(19) United States
(12) Patent Application Publication
(10) Pub. No.: US 2013/0325993 A1
(43) Pub. Date: Dec. 5, 2013

(54) GROUP BASED COMMUNICATION IN A SOCIAL NETWORKING SPACE

(71) Applicant: Suthindran Guru Rao, Karnataka (IN)

(72) Inventor: Suthindran Guru Rao, Karnataka (IN)

(73) Assignee: RAO'S INFOSOFT JOIN PVT. LTD., Karnataka (IN)

(21) Appl. No.: 13/981,057

(22) PCT Filed: Feb. 22, 2012
(86) PCT No.: PCT/IN12/00124

§ 371 Date: Jul. 22, 2013

(30) Foreign Application Priority Data
Feb. 22, 2011 (IN) 518/CHE/2011

(51) Int. Cl. H04L 29/06

(52) U.S. Cl. CPC H04L 65/403
USPC 709/206

(57) ABSTRACT

The present invention provides a method and system for enabling group based communication in a social networking space. In one embodiment, a method includes creating an online event associated with a context by a source group device of an originator of a source group and privately publishing the online event to publishers of target groups via the Internet so that the online event is privately distributed to one or more members of the target groups and one or more groups associated with the target groups. The method further includes tracking status of participation of the one or more members of the target groups, and the one or more associated groups in the online event using the source group device. Moreover, the method includes automatically sending reminders to one or more members who have not yet participated in the online event till a preset threshold limit is reached.

### RELATED APPLICATION

Benefit is claimed to India Provisional Application No. 518/CHE/2011, titled “METHOD AND SYSTEM FOR GROUP COMMUNICATION IN A SOCIAL NETWORKING SPACE” by RAO, Suthindran Guru, filed on 22 Feb. 2011, which is herein incorporated in its entirety by reference for all purposes.

### FIELD OF THE INVENTION

The present invention relates to the field of social networking, and more particularly relates to a group based communication in a social networking space.

### BACKGROUND OF THE INVENTION

Any large organization is normally split into small groups like chapters or branches or departments under a federation. The organization may be a high school, a college, a university, a business, a non-profit company, trade union, RWA, franchises having various divisions or any other group of people who desire to associate with each other as a group. All groups in an organization are identified as the federation of groups. In the federation of groups, the groups work independently even though they are associated with one or the other groups.

In order to communicate with the branches or chapters, offline communications such as courier, telephone, fax etc., are used which are not efficient in these modern days. Although, online communications such as emails are very fast in conveying the information, it requires more clicks and time when large number of groups/people involved. Also, consolidation of responses to a query or request requires patience for a person who sends the request.

Several social networking tools are available on the Internet that enables an individual to form a group and members to get registered with the group. Such social networking tools provide a way for the members to interact within a group or across groups. However, such social networking tools does not allow individual to have different levels of communication within the network of groups as the groups are hierarchy based. Hence, it may be cumbersome to reach the entire group, specific members or the union of group members at the same time.

### BRIEF DESCRIPTION OF THE ACCOMPANYING DRAWINGS

FIG. 1 is a schematic diagram illustrating a group based social networking space, according to one embodiment.

FIG. 2 is a block diagram illustrating a social networking system for enabling group based communication in the social networking space, according to one embodiment.

FIG. 3 is an exploded view of the group communication module, according to one embodiment.

FIG. 4 is a block diagram illustrating a social networking system for enabling group based communication in the social networking space, according to another embodiment.

FIG. 5 is a process flowchart illustrating an exemplary method of publishing an online event in a social networking space, according to one embodiment.

FIG. 6 is a screenshot view illustrating an online event creation wizard for creating and publishing online events in a social networking space, according to one embodiment.

FIG. 7 is a screenshot view illustrating a question creation window for creating a question associated with an online event, according to one embodiment.

FIG. 8 is a screenshot view illustrating a list of published events associated with the originator of the source group, according to one embodiment.

FIG. 9 is a screenshot view of a statics window showing statistics associated with an online event, according to one embodiment.

FIG. 10 is a block diagram of a group device showing various components for implementing embodiments of the present subject matter.

The drawings described herein are for illustration purposes only and are not intended to limit the scope of the present disclosure in any way.

### DETAILED DESCRIPTION OF THE EMBODIMENTS OF THE INVENTION

The present invention provides a method and system for enabling, group based communication in a social networking space. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

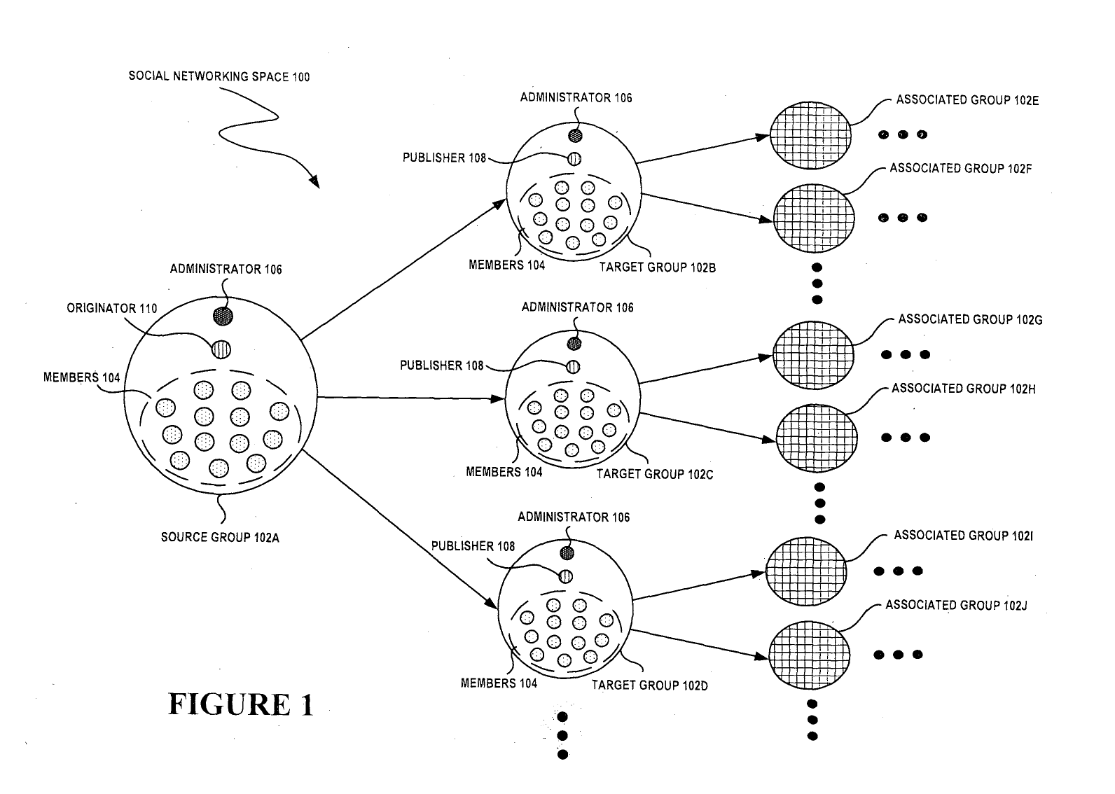

FIG. 1 is a schematic diagram illustrating a group based social networking space 100, according to one embodiment. In FIG. 1, the social networking space 100 includes a plurality of groups 102A-N directly or indirectly connected to each other. The plurality of groups 102A-N is connected such that groups which are directly connected to each other can communicate in the social networking space 100. Therefore, the groups which are directly connected to each other through a single level are termed as directly associated groups while the groups which are connected through more than one level are termed as indirectly associated groups.

With reference to FIG. 1, each of the plurality of groups 102A-N includes a plurality of members 104, an administrator 106 for managing activities associated with the respect group and its members, and a publisher 108. It can be noted that, a member in a group can be assigned a role of a publisher.

The plurality of groups 102A-N may include a source group 102A, and associated groups 102B-N. A source group 102A is a group from which an online event is initiated. The source group 102A includes an originator 110 who is assigned a role to create and publish online events to members 104 of the source group 102A and publisher 108 of the directly associated groups. An online event may be a question-answer session, online survey, an online poll, distribution of a template, planners, schedules or information associated with an activity and so on. The originator 110 may be among one of the members of the source group 102A. A target group is a group to which the online event is to be published. Further, one or more groups 102B-D directly associated with the source group 102A are also referred to as target groups.

In each of the associated groups 102B-N, the publisher is assigned role to review and forward the online event to members of the respective associated groups and its directly associated groups. The publisher is also allowed to collect statistics from the directly associated groups participating in the online event.

In the social networking space 100, the groups 102A-N are not associated with each other in a hierarchical manner. However, the online event is published in the social networking space 100 in a hierarchical manner. Further, the roles of an originator and a publisher can be transferred from one member to another based on the requirement. That is, the role of the originator originally assigned to one member who created and published the online event can be assigned to another member in the source group 102A while the online event is active.

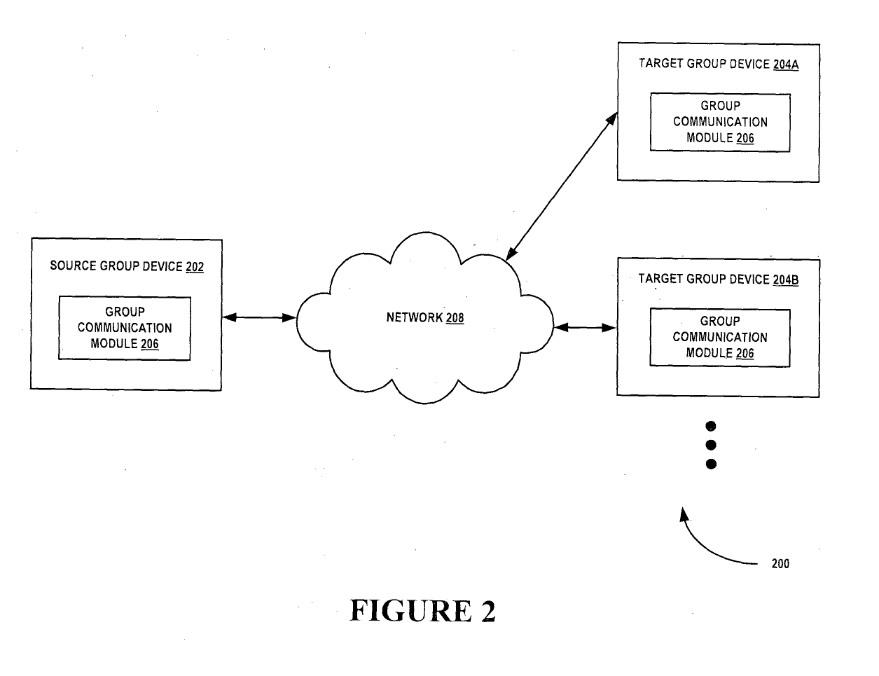

FIG. 2 is a block diagram illustrating a social networking system 200 for enabling group based communication in the social networking space 100, according to one embodiment. In FIG. 2, the social networking system 200 includes a source group device 202 and target group devices 204A-N. The source group device 202 is connected to the target group devices 204A-N via a network (e.g., wireless area network) 208.

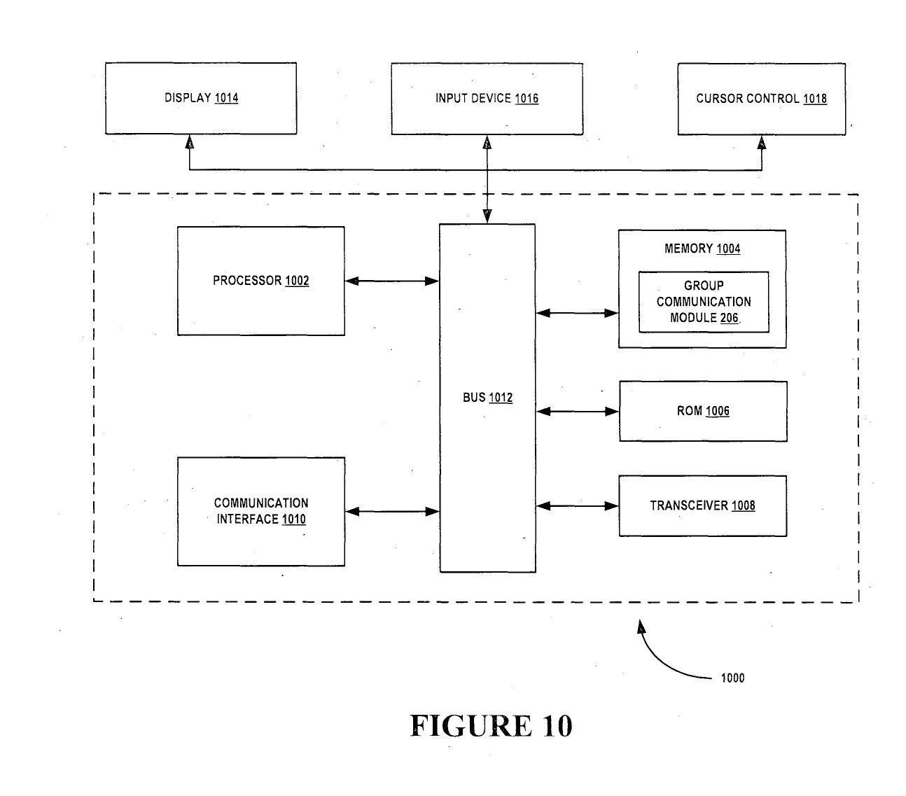

The source group device 202 is a computing device such as a laptop, a desktop, a mobile phone, a personal digital assistant, a tablet computer and the like associated with the originator 110 of the source group 102A. The target group devices 204A-N may include devices, such as laptops, desktops, mobile phones, personal digital assistants, tablet computers and the like, associated with the publishers 108 of the respective target groups 102B-D directly connected to the source group 102A. Although not illustrated in FIG. 2, one can envision that the social networking system 200 includes such devices associated with publishers of the associated groups 102E-N directly associated with the groups such as target groups 102B-D. Each of the devices, including the source group device 202 and the target group devices 204A-N, includes a group communication module 206 for enabling group based communication in the social networking space 100. Exemplary device having the group communication module 206 is illustrated in FIG. 10.

In an exemplary operation, the group communication module 206 in the source group device 202 enables the originator 110 to create an online event and set a threshold limit and/or follow up date and time to have effective participation from the target groups 102B-D. The group communication module 206 identifies one or more members 104 in the source group 102A and one or more target groups 102B-D for participating in the online event. The group communication module 206 publishes the online event to the one or more members 104 in the source group 102A and one or more publishers 108 of the target groups 102B-D via the Internet. For example, the online event is published by automatically sending an email to an email address of the members 104 of the source group 102A and the publishers 108 of the target groups 102B-D.

The group communication module 206 in the target devices 102B-D enables the publishers 108 of the target groups 102B-D to view the online event using the respective target devices 102B-D. Further, the group communication module 206 allows each of the publishers 108 of the respective target groups 102B-D to privately publish the online event to one or more members of the respective target groups 102B-D and/or one or more directly associated groups 102B-N. In one embodiment, the group communication module 206 restricts the publishers 108 of the target groups 102B-D from publishing the online event to one or more associated groups which belong to the target groups 102B-D.

The online event is published in a staged manner or a free flow manner. In case of staged publication, the publishers 108 review the online event and decide whether to participate in the online event or not based on the context of the online event. If the publishers 108 decide to participate in the online event, then the group communication module 206 publishes the online event to the one or more members 104 of the respective target groups 102B-D and/or the publishers 108 of the one or more directly associated groups. The group communication module 206 residing in devices of the publishers 108 of the directly associated groups further allows the publishers 108 to publish the online event to the members 104 of their respective directly associated groups and to publishers 108 of their directly associated groups. In this manner, the online event is published in the social networking space in a hierarchical manner based on a context of the online event.

In case of free flow publication, the group communication module 206 automatically distributes the online event among the one or more members 104 of the respective target groups 102B-D and/or the publishers 108 of the one or more directly associated groups.

The group communication module 206 allows the members 104 of the groups, to whom the online event is published, to participate in the published online event. For example, the online event may include a question with multiple choice answers, whereby the members 104 of the target groups 102B-D and the directly associated groups can participate in the online event by selecting an answer from the multiple choices. Accordingly, the group communication module 206 collects the responses (e.g., answer to the questions) to the online event submitted by the members 104.

During the online event, the group communication module 206 tracks status of participation by the members 104 in the online event. The group communication module 206 determines whether percentage of participation has reached the threshold limit at the preset follow-up date and time. If the participation percentage has reached the threshold limit, then the group communication module 206 displays statistics of participation and the responses associated with the online event on the source group device 202 of the originator 110. Otherwise, the group communication module 206 automatically sends reminders to the members 104 who have not yet participated in the online event. The reminders can be sent either via a text message or via an email to follow up with the target groups 102B-D and/or the associated groups until the participation reaches threshold limit. Also, the group communication module 206 is configured for sending reminders to the one or more members 104 as per their local time.

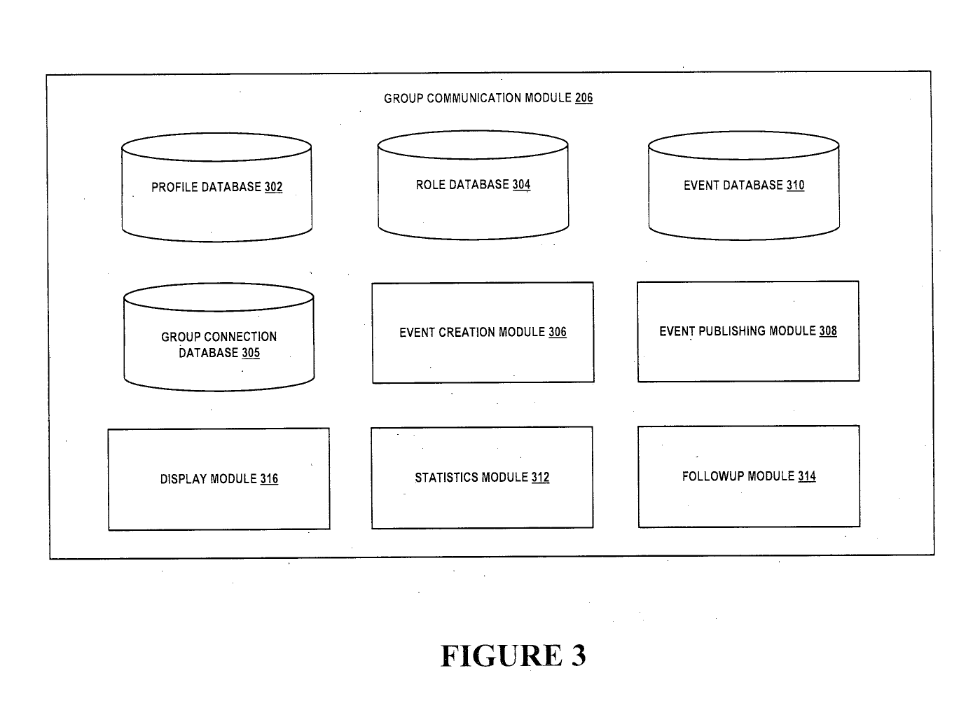

FIG. 3 is an exploded view of the group communication module 206 such as those shown in FIG. 2, according to one embodiment. The group communication module 206 includes a profile database 302, a role database 304, a group connections database 305, an event creation module 306, an event publishing module 308, an event database 310, a statistics module 312, a followup module 314 and a display module 316.

The profile database 302 contains personal and login information associated with the administrator 106, the publisher 108, the originator 110, and the members 1.04 belonging to the source group 102A, and the associated groups 102B-N in the social networking space 100. The role database 304 includes role information associated with the administrator 106, the publisher 108, and the originator 110. The roles are generally assigned to perform certain tasks associated with the online event. For example, a member who is assigned a role of an administrator manages its own group and its associated groups for enabling group based communication with other groups. Similarly, a member who is assigned a role of an originator can create and publish an online event in the social networking space 100. The group connections database 305 manages connections between various groups in the social networking space 100.

The event creating module 306 is configured for creating online events for publishing in the social networking space 100. The event publishing module 308 is configured for privately publishing online events in the social networking space 100. The event database 310 is configured for storing information associated with one or more online events. For example, the event database 310 stores information associated with one or more published or unpublished online events.

The statistics module 312 keeps a track of participation in the online event by the members 104 of the various groups 102A-N in the social networking space 100. The statistics module 312 is configured for determining whether the percentage amount of participation has reached a preset threshold limit at the predefined date and time. If the participation percentage is less than the preset threshold limit, then the follow-up module 314 is configured for automatically sending reminders to the members 104 who are yet to participate in the online event. The reminders can be sent via a text message or an e-mail. The display module 316 is configured for displaying the Consolidated statistics of participation for the online event.

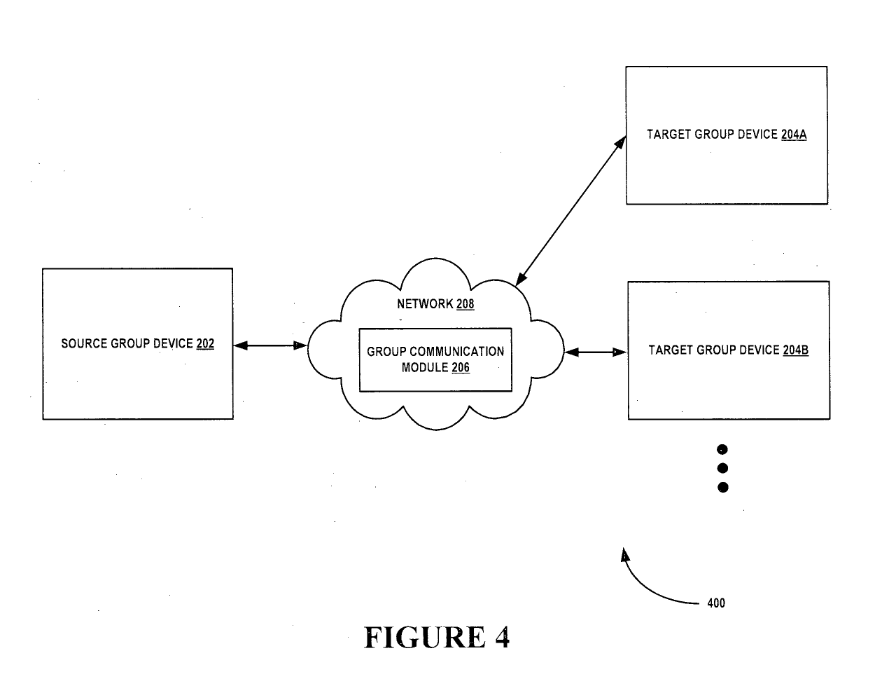

FIG. 4 is a block diagram illustrating a social networking system 400 for enabling group based communication in the social networking space 100, according to another embodiment. It is appreciated that, the social networking system 400 is same as the social networking system 200, except that the group communication module 206 resides in the network 208. In an exemplary implementation, the group communication module 206 may reside in an application server of the network 208, whereby the originator 110, the publishers 108 and the members 104 of different groups can access the group communication module 206 using devices connected to the network 208.

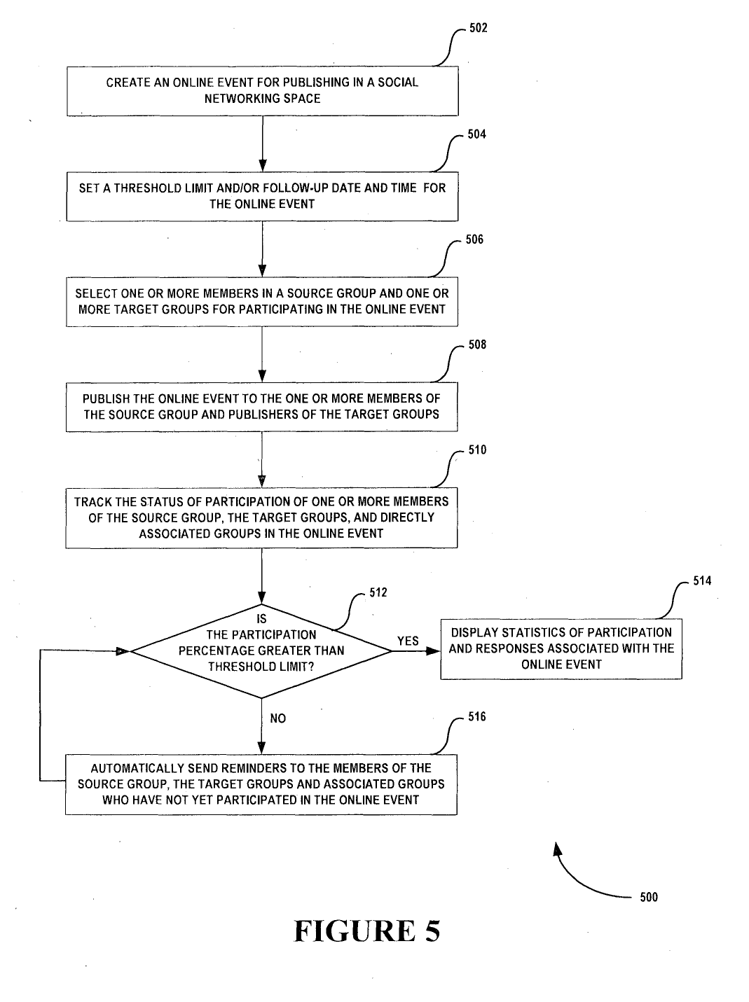

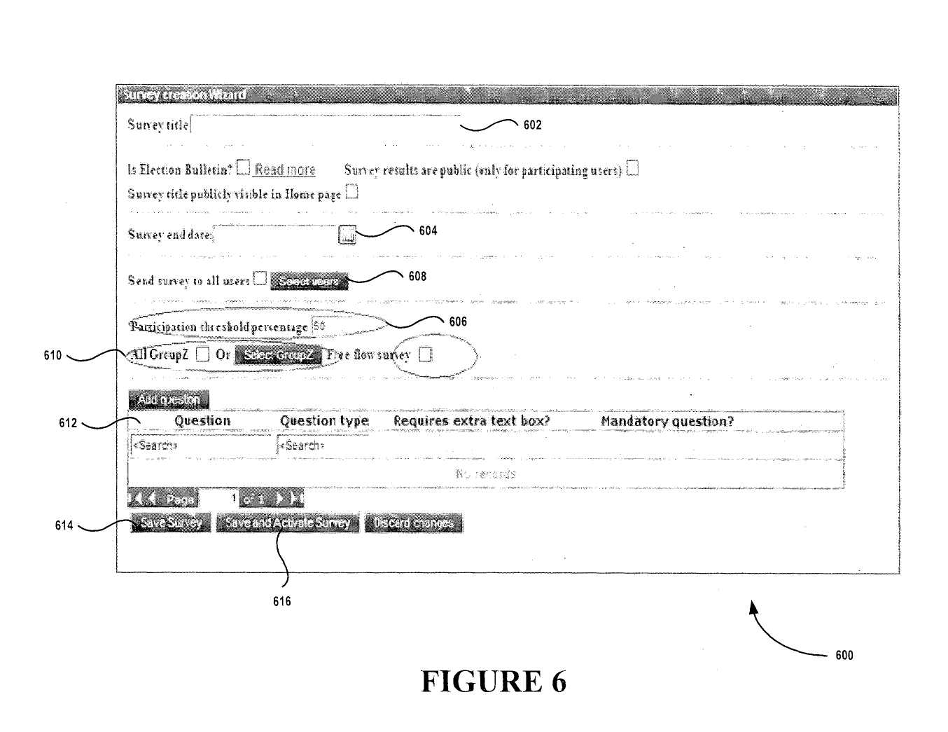

FIG. 5 is a process flowchart 500 illustrating an exemplary method of publishing an online event in the social networking space 100, according to one embodiment. At step 502, an online event is created for publishing in the social networking space. In some embodiments, the online event is created by the originator 110 using the source group device 202. In these embodiments, the online event is created by the originator 110 using an online event creation wizard (as shown in FIG. 6) displayed on the source group device 202. Once the online event is created, a threshold limit and/or follow up date and time is set to have effective participation from the target groups 102B-D, at step 504. At step 506, one or more members 104 in the source group 102A and one or more directly associated groups 102B-D (hereinafter referred to as target groups) selected for participating in the online event.

At step 508, the online event is published to the one or more members 104 in the source group 102A and one or more publishers 108 of the target groups 102B-D via the Internet. For example, the online event is published by sending an email to email address of the publishers 108. The publishers 108 can thus view the online event using the respective target devices 204A-N. Further, each of the publishers 108 of the respective target groups 102B-D can publish the online event to one or more members 104 of the respective target groups 102B-D and/or one or more directly associated groups. It can be noted that, the publishers 108 of the target groups 102B-D are not allowed to publish the online event to one or more associated groups which belong to the target groups 102B-D. The online event can be published in a staged manner or a free flow manner. In case of staged publication, the publishers 108 review the online event and decide whether to participate in the online event or not based on the context of the online event. If the publishers 108 decide to participate in the online event, then the publishers 108 publish the online event to the one or more members 104 of the respective target groups 102B-D and/or the publishers 108 of the one or more directly associated groups. The publishers 108 of the directly associated groups are in-turn allowed to publish the online event to the members 104 of their respective directly associated groups and to publishers 108 of their directly associated groups.

In case of free flow publication, the online event is automatically distributed among the one or more members 104 of the respective target groups 102B-D and/or the publishers 108 of the one or more directly associated groups. In this manner, the online event created by the originator 110 is privately published in the social networking space 100. It can be noted that, the online event is published to the publishers 108 of the target groups 102B-D by the originator 110 of the source group 102A, and publishers 108 of the directly associated groups by respective publishers 108 of the target groups 102B-D based on the context of the online event. Also, the online event is published to the members 108 of the target groups 102B-D and the directly associated groups by respective publishers 108 based on the context of the online event.

The members 104 of the target groups 102B-D and the directly associated groups are allowed to participate in the published online event. For example, the online event may include a question with multiple choice answers, whereby the members 104 of the target groups 102A-D and the directly associated groups can participate in the online event by selecting an answer from the multiple choices. Accordingly, responses (e.g., answer to the questions) to the online event submitted by the members 104 of the target groups 102B-D and its directly associated groups are collected and stored.

At step 510, the status of participation of one or more members 104 of the source group 102A, the target groups 102B-D, and the directly associated groups in the online event is tracked. In some embodiments, the statistics of participation associated with the one or more members 104 of the source group 102A and the target groups 102B-D is collected by the publisher 108 of the source group using the source group device 202. In these embodiments, the statistics of participation of one or more members 104 of the respective target groups 102B-D and the groups directly associated with the target groups 102B-D is collected by publishers 108 of the respective target groups using the target group devices 204A-N. This process of collecting the statistics continues till the statistics of participation is collected from the last directly associated group in the social networking space 100 to which the online event is published. Further, the publishers 108 of the target groups 102B-D send statistics of participation to the publisher 108 of the source group 102A using the respective target group devices 204A-N. Accordingly, the source group device 202 consolidates and displays the statistics of participation from the groups to which the online event is published in the social networking space.

At step 512, it is determined whether percentage of participation has reached the threshold limit at the preset follow-up date and time. If the participation percentage has reached the threshold limit, then at step 514, statistics of participation and the responses associated with the online event are displayed at the source group device 202 of the originator 110. Otherwise, at step 516, reminders are automatically sent to the members 104 of the target groups 102B-D and the associated groups who have not yet participated in the online event. The reminders can be sent either via a text message or via an email to follow up with the target groups 102B-D and/or the associated groups until the participation reaches threshold limit.

FIG. 6 is a screenshot view illustrating an online event creation wizard 600 for creating and publishing online events in the social networking space 100, according to one embodiment. The online event creation wizard 600 includes a title field 602, an end date field 604, a threshold participation limit field 606, a target members selection field 608, a target groups selection field 610, an question field 612, a save event field 614, and a save and activate survey field 616.

The title field 602 enables the originator 110 of an online event to enter a title associated with the online event. The end date field 604 facilitates the originator 110 of the online event to set a last date for participating in the online event. The threshold participation limit field 608 allows the originator 110 to set a threshold limit for participating in the online event. For example, the threshold participation limit can be selected from the percentage ranging of 1% to 100%. The target members selection field 608 allows the originator 110 to select one or more members 104 of the source group 102A to whom the online event will be posted for participation based on the context of the online event. The target groups selection field 610 allows the originator 110 to select one or more groups directly associated with the source group 102A to whom the online event will be posted for participation based on the context of the online event. Alternatively, the target groups selection field 610 allows the originator 110 to select all directly associated groups as target groups. Further, the target groups selection field 610 allows to the originator 110 to select whether the online event is a staged event or a free flow event. In case of staged event, the online event is published to the respective publishers 108 of the target groups 102B-D selected by the originator 110 using the target groups selection field 610. The publisher 108 of the respective one of the target groups 102B-D may decide whether to publish the online event to one or more members 104 based on the context of the online event. On the contrary, in case the originator 110 selects a free flow event, the online event is published to one or more members 104 of each of the target groups 102B-D selected by the originator 110 using the target groups selection field 610. This is a case when the originator 110 wishes to publish the online event to the members 104 of the target groups 102B-D in a free flow manner.

The question field 612 enables the originator 110 to create a question associated with the online event for publishing to the members 104 of the source group 102A and directly and indirectly associated groups 102B-N. The online event created by the originator 110 using the online event creation wizard 600 is based on the question created by the originator 110. The members and groups selected using the target member selection field 608 and the target groups selection field 610 participate in the online event by answering the question published in the online event. It is understood that, one or more questions can be created and published by the originator 110 in a single online event. The save field 614 enables the originator 110 to save the online event created using the online event creation wizard 600. The save and publish event field 616 enables the originator to save and publish the online event to the target members 104 of the source group 102A and the publishers 108 of the target groups 102B-D. Thus, the online event is sent to email IDs of respective publishers 108 of the target groups 102B-D and also the members 104 of the source group 102A. The publishers 108 of the target groups 102B-D are responsible for forwarding the online event to the members 104 of the respective target group and other directly associated groups. The online event is thus shared at the group level in the social networking space 100.

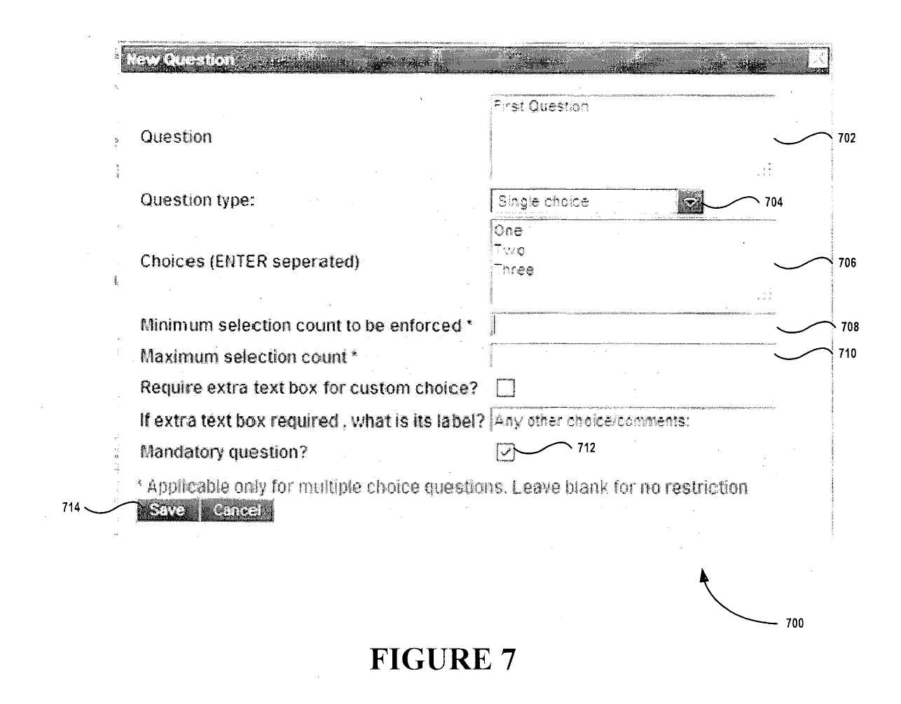

FIG. 7 is a screenshot view illustrating a question creation window 700 for creating a question associated with the online event, according to one embodiment. The question creation window 700 is displayed on the source group device 202 when the originator 110 selects an add question option in the question field 612. The question creation window 700 enables the originator 110 to add a question to the online event of his/her choice for publishing to the members 104 of the source group 102A and the publishers 108 of the target groups 102B-D in the social networking space 100. The question creation window 700 includes a question field 702, a question type field 704, a choice field 706, a minimum selection count to be enforced field 708, a minimum selection count field 710, a mandatory question field 712, and a save button 714.

The question field 702 allows the originator 110 to create a question associated with an online event of his/her choice. The question type field 704 enables the originator 110 to select whether the question in the question field 702 is a single choice or multiple choices via a drop down menu. If the question is multiple choices, then the choice field 706 allows the user to enter choice of answer to the question.

The minimum selection count to be enforced field 708 and the minimum selection count field 710 enables the originator 110 to set minimum and maximum number of options that the user has to select from the multiple choices.

The mandatory question field 712 enables the originator 110 to make the question to be mandatory or optional. If the question is mandatory, the originator 110 can check the check box associated with the mandatory question field 712 to mark the question as mandatory. The save button 714 enables the originator 110 to save the question created using the question creation window 700. Thus, the question is saved and displayed in the question field 612 of the online event creation wizard 600. For example, when the event is published by the originator 110, the question along with choice of answers is displayed on the devices associated with the members 104 of the source group 102A and the publishers 108 of the respective target groups 102B-D.

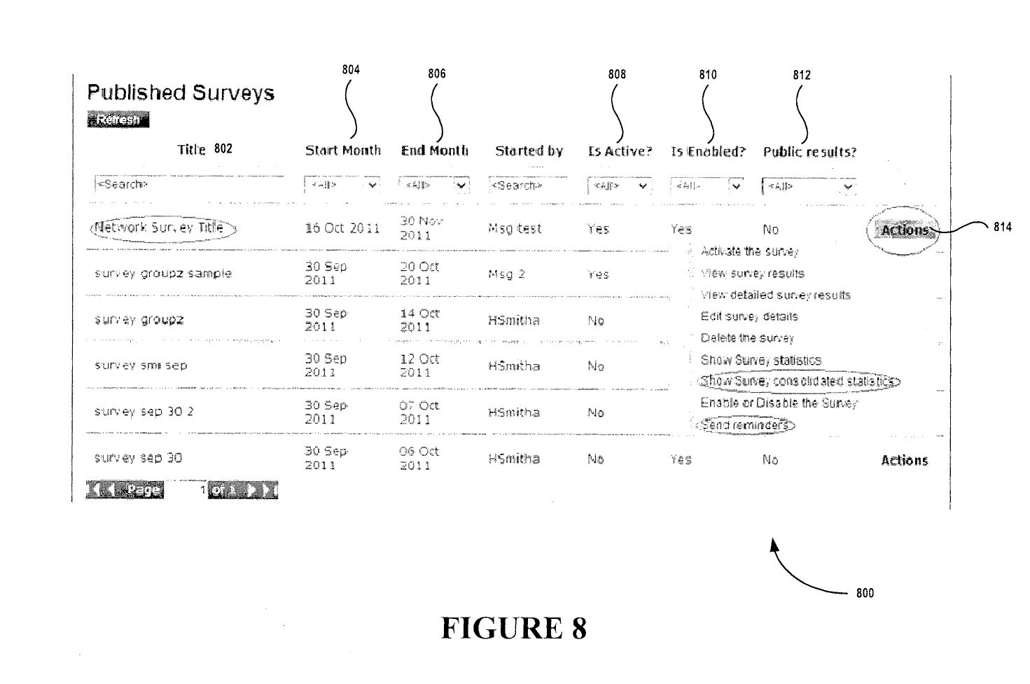

FIG. 8 is a screenshot view illustrating a list of published events 800 associated with the originator 110 of the source group 102A, according to one embodiment. When the originator 110 creates and publishes an online event using the online event creation wizard 600, the online event is displayed in the list of published events 800. The list of published events 800 displays a title field 802, a start date field 804, an end date field 806, an active status field 808, an enabled field 810, and a public results field 812.

The title field 802 displays title associated with published online events. The start date field 804 indicates a start date associated with each published online event. The end date field 806 indicates an end date associated with each published online event. The active status field 808 displays a status of the published online event as active or inactive. The enabled field 810 indicates whether the public is allowed to view statistics associated with the online event after the end date associated with the online event. For example, if the enabled field 810 displays “enabled”, the online event is enabled for public viewing. If the enabled field 810 displays “disabled”, statistics associated with the online event is disabled from public viewing. The public results field 812 indicates whether the statistics associated with the online event is available for public viewing.

Each of the published online event is provided with an action button 814 so that the originator 110 can perform actions associated with respective published online event. For example, the originator 110 can activate/deactivate the online event, view results, edit results, delete the online event, view statistics, send follow-up reminders, and so on.

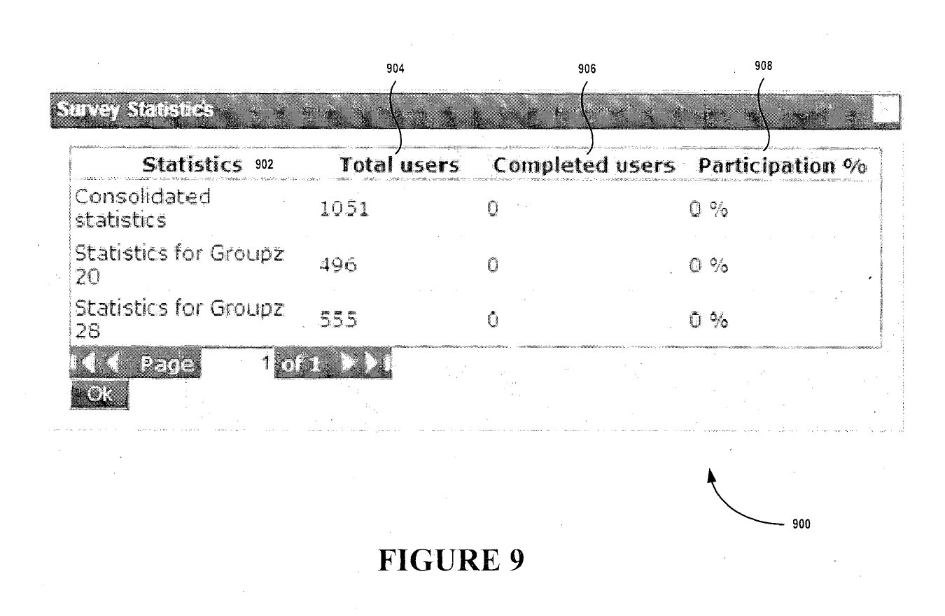

FIG. 9 is a screenshot view of a statistics window 900 showing statistics associated with an online event, according to one embodiment. The statistics window 900 displays a statistics field 902, a total members field 904, a completed participants field 906, and a participation percentage field 908. The statistics field 902 indicates the type of statistics associated with the online event. For example, the statistics field 902 displays consolidated statistics data for all groups 102A-N, and statistics data associated with each of the groups 102A-N. The total participants field 904 displays total number of members 104 to whom the online event is posted. The completed members field 906 displays number of members 104 participated in the online event. The participation percentage field 908 displays percentage amount of participation by the members 104 of the source group 102A and the other groups. 102B-N in the online event.

FIG. 10 is a block diagram of a group device 1000 showing various components for implementing embodiments of the present subject matter. In FIG. 10, the group device 1000 includes a processor 1002, memory 1004, a read only memory (ROM) 1006, a transceiver 1008, a bus 1010, a communication interface 1012, a display 1014, an input device 1016, and a cursor control 1018. It is appreciated that the group device 1000 is an exemplary embodiment of the source group device 202 and the target group devices 204A-N.

The processor 1002, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 1002 may also include embedded controllers, such as generic or programmable logic devices or arrays, application specific integrated circuits, single-chip computers, smart cards, and the like.

The memory 1004 and the ROM 1006 may be volatile memory and non-volatile memory. The memory 704 includes the group based communication module 206 for enabling group based communication in the social networking space, according to one or more embodiments described in FIGS. 1-9. A variety of computer-readable storage media may be stored in and accessed from the memory elements. Memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, and the like.

Embodiments of the present subject matter may be implemented in conjunction with modules, including functions, procedures, data structures, and application programs, for performing tasks, or defining abstract data types or low-level hardware contexts. Machine-readable instructions stored on any of the above-mentioned storage media may be executable by the processor 1002. For example, a computer program may include machine-readable instructions capable of enabling group based communication in the social networking space, according to the teachings and herein described embodiments of the present subject matter. In one embodiment, the program may be included on a compact disk-read only memory (CD-ROM) and loaded from the CD-ROM to a hard drive in the non-volatile memory.

The bus 1010 acts as interconnect between various components of the group device 102. The display 1014 is configured for displaying a graphical user interface associated with group communication such as those shown in FIGS. 6-9. The input device 1016 may be a mouse, trackpad, keypad, keyboard, touch screen and the like configured for receiving the inputs from the user (e.g., originator, publisher, member, etc.) of the group device 1000. The components such as the transceiver 1008, the communication interfaces 1012, and the cursor control 1018 are well known to the person skilled in the art and hence the explanation is thereof omitted.

The present embodiments have been described with reference to specific example embodiments; it will be evident that various modifications and changes may be made to these embodiments without departing from the broader spirit and scope of the various embodiments. Furthermore, the various devices, modules, selectors, estimators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

1. A computer-implemented method for providing group based communication in a social networking space, the method comprising:
creating an online event associated with a context by a source group device of an originator of a source group;
privately publishing the online event to publishers of target groups via the Internet so that the online event is privately distributed to one or more members of the target groups and one or more groups associated with the target groups based on the context of the online event; and
tracking status of participation of the one or more members of the target groups, and the one or more associated groups in the online event using the source group device.

2. The method of claim 1, further comprising:
displaying responses received from the one or more members of the target groups and the one or more associated groups to the online event on the display of the source group device.

3. The method of claim 1, further comprising:
setting a threshold level of participation in the online event.

4. The method of claim 1, further comprising:
determining whether the participation in the online event is less than or equal to a threshold level of participation by the source group device based on the tracked status of participation;
if so, sending a follow up reminders to one or more of the publishers of the target group who have not participated in the online event; and
if not, displaying successful accomplishment of the threshold level of participation in the online event on the display of the source group device.

5. The method of claim 1, wherein privately publishing the online event
associated with the context to publishers of target groups, comprises:
selecting one or more of groups associated with the source group as target groups based on the context of the online event; and
privately publishing a request to participate in the online event to publishers of the target groups.

6. The method of claim 1, wherein privately publishing the request to participate in the online event to the publishers of the target groups comprises:
enabling the publishers of the target groups to review and publish the request to participate in the online event to one or more members of the target group and one or more groups directly associated with the respective target groups based on the context of the online event.

7. The method of claim 1, wherein enabling the publishers of the target groups to review and publish the request to participate in the online event to the one or more members of the target group and the one or more groups directly associated with the respective target groups based on the context of the online event comprises:
restricting the publishers of the target groups from publishing the online event to one or more associated groups Which belong to the target groups.

8. The method of claim 1, further comprising:
selecting one or more members of the source group for participating in the online event based on the context of the online event;
privately publishing the online event to the selected members of the source group; and
tracking status of participation of the selected members of the source group in the online event; and
displaying responses received from the selected members of the source group on the display of the source group device.

9. (canceled)

10. A non-transitory computer-readable storage medium with an executable program stored thereon, wherein the program instructs a microprocessor to perform the following steps, comprising:
privately publishing an online event to publishers of target groups via so that the online event is privately distributed to one or more members of the target groups and one or more groups associated with the target groups based on the context of the online event; and
tracking status of participation of the one or more members of the target groups, and the one or more associated groups in the online event.

11. The storage medium of claim 10, wherein the program further instructs the microprocessor to perform the following step comprising:
setting a threshold level of participation in the online event.

12. The storage medium of claim 10, wherein the program further instructs the microprocessor to perform the following steps comprising:
determining whether the participation in the online event is less than or equal to a threshold level of participation based on the tracked status of participation;
if so, sending a follow-up reminder to one or more of the publishers of the target group who have not participated in the online event; and
if not, displaying successful accomplishment of the threshold level of participation in the online event.

13. The storage medium of claim 10, wherein the program further instructs the microprocessor to perform the following steps comprising:
selecting one or more members of the source group for participating in the online event based on the context of the online event;
privately publishing the online event to the selected members of the source group; and
tracking status of participation of the selected members of the source group in the online event; and
displaying responses received from the selected members of the source.

14. An apparatus comprising:
an event creation module configured for creating an online event in the social networking environment;
an event publishing module configured for publishing the online event to one or more target group members;
a statistics module configured for tracking the participation of one or more target group members to the online event;
a follow-up module configured for automatically sending reminders to the members who are yet to participate in the online event; and
a display module configured for displaying the consolidated statistics of participation for the online event.

15. The apparatus of claim 14, wherein the display module is configured for:
displaying responses received from the one or more members of the target groups and the one or more associated groups to the online event.

16. The apparatus of claim 14, wherein the statistics module is configured for:
setting a threshold of participation in the online event.

17. The apparatus of claim 14, wherein the follow up module is configured for:
determining whether the participation in the online event is less than or equal to a threshold level of participation based on the tracked status of participation;
if so, sending a follow up reminders to one or more of the publishers of the target group who have not participated in the online event; and
if not, displaying successful accomplishment of the threshold level of participation in the online event.

18. The apparatus of claim 14, wherein in publishing the online event associated with the context to publishers of target groups, the even publishing module is configured for:
selecting one or more of groups associated with the source group as target groups based on the context of the online event; and
privately publishing a request to participate in the online event to publishers of the target groups.

19. The apparatus of claim 14, wherein the event publishing module is configured for:
selecting one or more members of the source group for participating in the online event based on the context of the online event;
privately publishing the online event to the selected members of the source group; and
tracking status of participation of the selected members of the source group in the online event; and
displaying responses received from the selected members of the source group.
